(19) United States
(12) Patent Application Publication
(10) Pub. No.: US 2004/0024801 A1
(43) Pub. Date: Feb. 5, 2004

(54) System and method for computing histograms with exponentially-spaced bins

(76) Inventors: Robert A. Hamilton, Mountain View, CA (US); Steven Greenbaum, Palo Alto, CA (US); Stanley T. Jefferson, Palo Alto, CA (US)

Correspondence Address: AGILENT TECHNOLOGIES, INC., Legal Department, DL429, Intellectual Property Administration, P.O. Box 7599, Loveland, CO, 80537-0599, US

(21) Appl. No.: 10/209,978

(22) Filed: Jul. 31, 2002

(51) Int. Cl. G06F 7/38

(52) U.S. Cl. 708/490

(57) ABSTRACT

A system and method for computing histograms with exponential spacing of bins translates a fixed-point data sample that is to be placed in a bin to a floating-point representation (assuming the original data sample is not already in that particular format), estimates the base-2 logarithm of the floating-point representation, calculates an approximate histogram bin number based on the base-2 logarithm, and then adjusts the approximate bin number based on a comparison between the data sample and a data value associated with the approximate bin number.

### BACKGROUND OF THE INVENTION

As the designs of electronic test instruments, such as digital storage oscilloscopes, logic analyzers, spectrum analyzers, transmitter testers and the like, mature over time, users of these devices expect progressively more functionality to aid them in their increasingly difficult and complex test and measurement tasks. One particular function currently integrated into some test instruments is the Power Complementary Cumulative Distribution Function (CCDF), which is an important tool for wireless communications manufacturers in quantifying the peak power characteristics of digitally modulated transmissions. The information from the CCDF, usually displayed on a test instrument graphically, is employed by those manufacturers to guide them in enhancing their circuit designs for optimum wireless transmission performance.

Unfortunately, as implemented in most test instruments, the CCDF, even though usually implemented with digital hardware, is not capable of being performed in real-time, and can require 15 seconds or more to calculate for a typical set of data samples. As a result, the CCDF tends to be calculated and displayed statically, whereby data collection is terminated while the CCDF is computed. If the CCDF calculation were more real-time in nature, the CCDF could be displayed and refreshed continuously while the collection of data progresses indefinitely. Such an enhancement would provide test equipment users greater insight into the strengths and weaknesses of their product designs.

The most computationally intensive portion of calculating the CCDF is the placement of data samples into exponentially-spaced “bins” of a histogram according to the power level of each sample. An example of such a histogram is shown in FIG. 1. The histogram 1 contains a number of bins 10, wherein each bin 10 represents a range of power values in which a data sample may reside. The height of each bin 10 represents the number of samples captured that reside in the range represented by that bin 10. The horizontal span of each bin 10 increases exponentially when proceeding from left to right. As shown in FIG. 1, the histogram 1 is plotted along a horizontal logarithmic scale representing the power level of each sample relative to an average power level. Each bin 10 thus represents some portion of that range, commonly measured in decibels (dB). For reference purposes, the number of decibels associated with a normalized power value P of a data sample is defined as dB=10 log₁₀ P.

The possible range of power levels spanned by histogram 1 is (1≦P<10²⁰), representing 10 (log₁₀ 10²⁰)=10(20)=200 decibels. The resulting number of bins 10, each one-tenth of a decibel wide in FIG. 1, required to form the entire histogram is 2000, numbered sequentially from 0 to 1999, with each bin number b representing the power value range (10^{0.01b}≦P<10^{0.01(b+1)}).

The correct histogram bin number b for the normalized power value P of each data sample may be ascertained by calculating the base-10 logarithm of the value, multiplying by 100, and then truncating the result. In mathematical terms, since 10^{0.01b}≦P<10^{0.01(b+1)}:

log₁₀(10^{0.01b})≦log₁₀ P<log₁₀(10^{0.01(b+1)})

0.01b≦log₁₀ P<0.01(b+1)

b≦100 (log₁₀ P)<b+1

Therefore, b=floor (100 (log₁₀ P))

However, base-10 logarithm functions typically involve significant computation, making performance of the logarithm difficult to complete in real-time for every sample captured. This is especially true for fast sampling times, which can be 10 nanoseconds or less in many current electronics test and measurement systems. Direct computation of logarithmic functions at these sampling rates is costly in the amount of circuitry required, thereby consuming an inordinate amount of the “footprint,” or surface area, available in an integrated circuit (IC).

Alternate methods of performing the histogram calculations in real-time have been considered, but these possible solutions also exhibit various circuit space penalties. Table-based implementations of the base-10 logarithm function generally require large tables and extensive support circuits. Solutions involving a series-based approximation of the logarithm function require a significant amount of circuitry due to the number of multipliers needed. A circuit using a direct binary search on the boundaries of the histogram bins requires a large number of concurrent searches if a large number of histogram bins are involved. For example, in our case in FIG. 1 of 2000 bins, 11 (=ceiling (log₂ (2000))) lookup and compare operations typically would be necessary to locate the correct bin for a sample. To process one sample per clock period, 11 searches could progress simultaneously, but such a method would also require multiple copies of the table to support the simultaneous searches, thus incurring a significant space and complexity penalty.

Therefore, from the foregoing, a new system and method providing for the placement of data samples into exponentially-spaced histogram bins that would allow the samples to be processed in real-time with a space-efficient implementation would be advantageous.

### SUMMARY OF THE INVENTION

Embodiments of the present invention, to be discussed in detail below, represent a system and method that compute histograms with exponential bin spacing in a time- and space-efficient manner. Assuming a data sample in fixed-point format to be placed in a bin, the data sample is first translated into a floating-point representation of the data sample. Such translation is not required if the data sample is initially available in floating-point format. An approximate base-2 logarithm of the floating-point representation is then generated. An approximate histogram bin number associated with the logarithm is then produced. A data value representing the approximate bin number is then compared with the data sample to adjust the approximate bin number to yield an exact bin number.

The use of base-2 arithmetic in embodiments of the invention allow real-time, space-efficient generation of the bin number in an exponential histogram due to the efficient implementations possible in digital hardware or software of base-2 calculations compared to decimal-based arithmetic.

Other aspects and advantages of the invention will become apparent from the following detailed description, taken in conjunction with the accompanying drawings, illustrating by way of example the principles of the invention.

### BRIEF DESCRIPTION OF THE DRAWINGS

FIG. 1 is a graphical representation of a specific histogram with exponential spacing of bins.

FIG. 2 is a block diagram of an overall system of computing histograms with exponential spacing of bins according to an embodiment of the invention, assuming a data sample in fixed-point format.

FIG. 2A is a block diagram of an overall system of computing histograms with exponential spacing of bins according to an embodiment of the invention, assuming a data sample in floating-point representation.

FIG. 3 is a block diagram of a fixed-point to floating-point translator from FIG. 1 according to an embodiment of the invention.

FIG. 4 is a block diagram of a base-2 logarithm estimator from FIG. 1 according to an embodiment of the invention.

FIG. 5 is a block diagram of an approximate histogram bin calculator from FIG. 1 according to an embodiment of the invention.

FIG. 6 is a block diagram of a histogram bin adjuster from FIG. 1 according to an embodiment of the invention.

FIG. 7 is a block diagram of a pipelined version of the overall system of FIG. 2 according to an embodiment of the invention. FIG. 7A is a block diagram of a pipelined version of the overall system of FIG. 2A according to an embodiment of the invention.

FIG. 8 is a flowchart describing a method of computing histograms with exponential spacing of bins according to an embodiment of the invention.

### DETAILED DESCRIPTION OF THE PREFERRED EMBODIMENTS

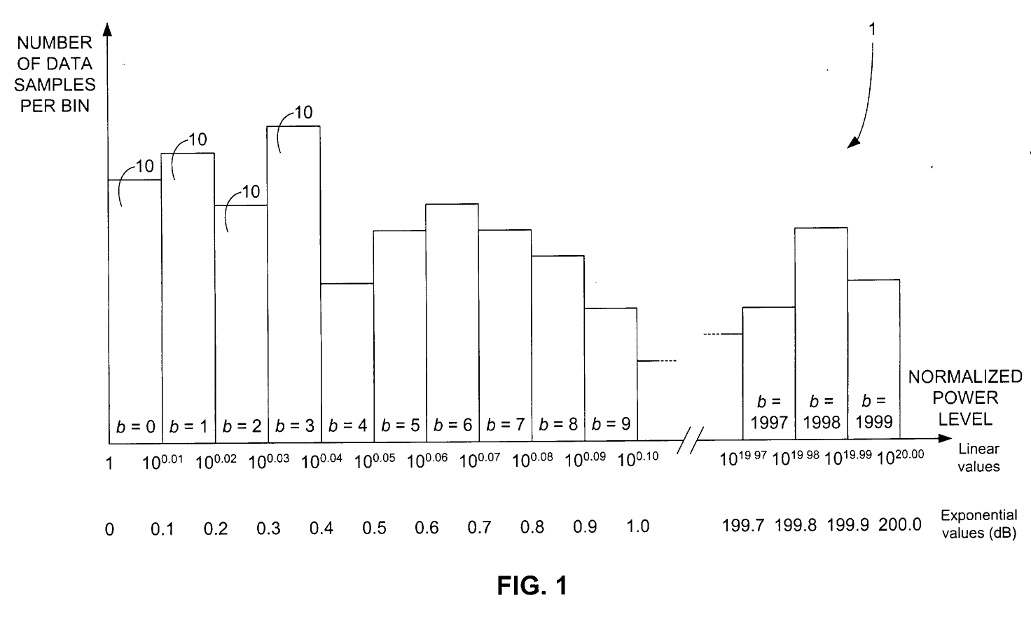

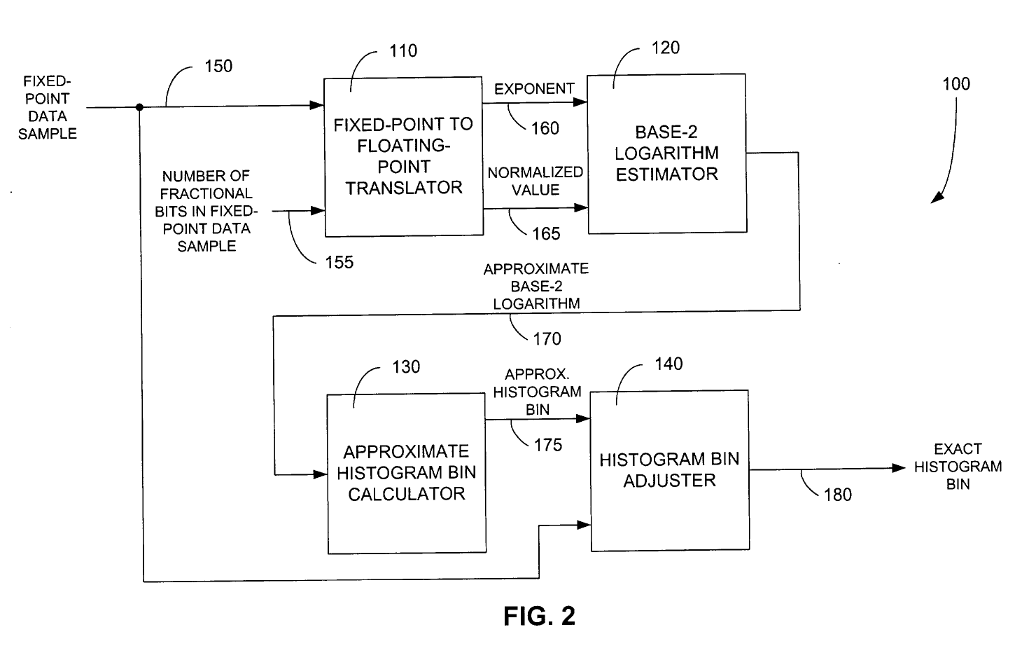

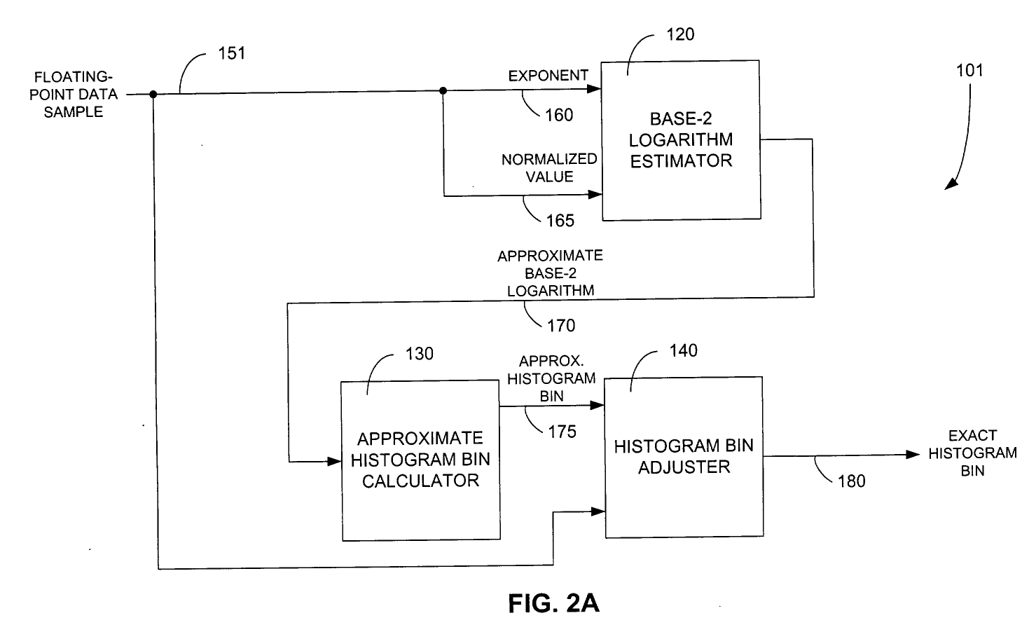

Embodiments of the invention, systems 100 and 101 for computing histograms with exponential spacing of bins, are shown in the block diagrams in FIG. 2 and FIG. 2A. A fixed-point data sample 150 (for system 100) or a floating-point data sample 151 (for system 101) (collectively, a data sample 150, 151) is used as input in order to generate an exact histogram bin number 180. In electronic test instruments, such as spectrum analyzers, which calculate the Power Complementary Cumulative Distribution Function (CCDF), the data sample 150, 151 represents a power value that is to be placed within one of a number of exponentially-spaced bins in a histogram, such as the one displayed in FIG. 1. In other applications requiring the computation of a histogram with exponentially-spaced bins, the data sample 150, 151 may represent any quantifiable value. Additionally, although embodiments of the invention disclosed herein are envisioned for use in electronic test and measurement equipment, many systems and methods requiring the calculation of histograms with exponential spacing of bins would benefit from the use of embodiments of the present invention.

The amount of precision, in terms of the number of bits required for any portion of the system 100, is dependent upon the characteristics of the specific histogram being computed. Specific constraints of system 100 pertaining to all disclosed embodiments are noted below.

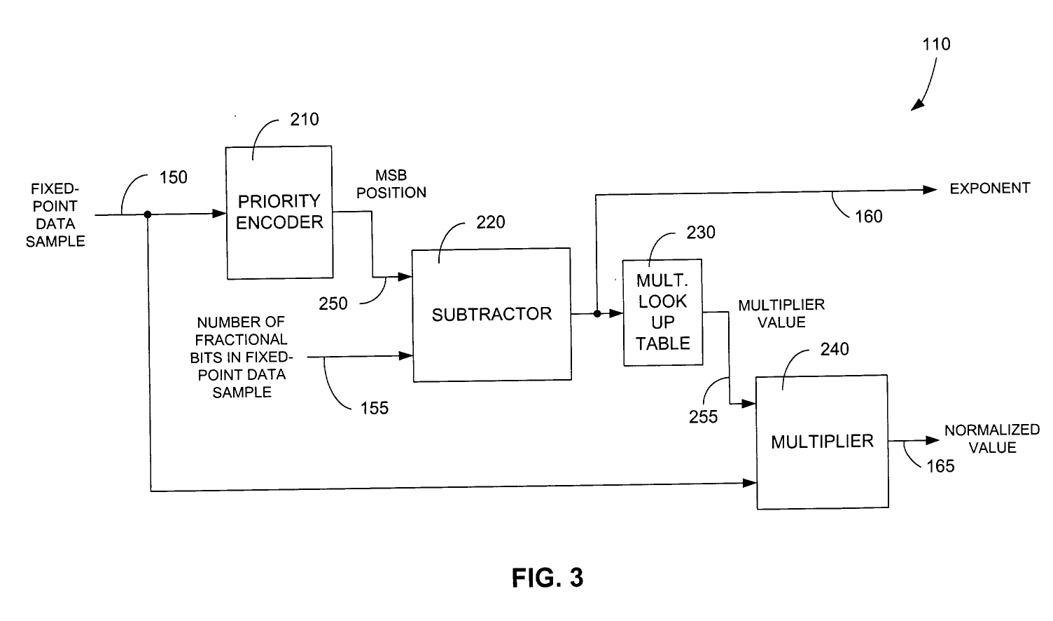

As shown in FIG. 2, the system 100 has four main components: a fixed-point to floating-point translator 110, a base-2 logarithm estimator 120, an approximate histogram bin calculator 130, and a histogram bin adjuster 140. The system 101 of FIG. 2A is the same system with the exception of the floating-point translator 110, which is not required in that case since the floating-point data sample 151 may be taken directly as input by the base-2 logarithm estimator 120. FIGS. 3 through 6 describe an embodiment of each of these components of the systems 100, 101 in greater detail. While the embodiments herein disclosed are those currently contemplated, other embodiments providing the same functionality described for each of the components 110, 120, 130, 140 could be utilized.

The fixed-point to floating-point translator 110, as shown in FIG. 3, takes the fixed-point data sample 150 and the number of fractional bits 155 in the fixed-point data sample 150 to generate the exponent 160 and the normalized value 165 of the floating-point representation of the fixed-point data sample 150. The normalized value 165 essentially is a shifted version of the fixed-point data sample 150 that yields a binary fixed-point number less than two, but greater than or equal to one. A priority encoder 210 is employed to determine the location of the most significant bit (MSB) position 250 that contains a ‘one.’ The number of fractional bits 155 is then subtracted by the MSB position 250 by way of a subtractor 220 to yield the number of bit positions the decimal point of the fixed-point data sample 150 that would have to be shifted to the left to normalize the fixed-point data sample 150. This number represents the exponent 160 of the floating-point representation of the fixed-point data sample 150.

The exponent 160 is also used as an index to a multiplier lookup table 230 that holds a multiplier value 255 for each possible value of the exponent 160. Each multiplier value 255 represents the value by which the fixed-point data sample 150 must be multiplied to shift the decimal point in the fixed-point data sample 150 a number of places to the left equivalent to the value of the exponent 160. A multiplier 165 is then used to multiply the fixed-point data sample 150 by the multiplier value 255 to generate the normalized value 165 of the floating point representation of the fixed-point data sample 150.

For example, assuming a fixed-input data sample of 1001.0110001, the resulting exponent 160 would be 3, that being the number of bits the decimal point would be shifted to the left. The associated normalized value 165 would be 1.0010110001, assuming the same number of bits were maintained throughout the operation. This number represents a shifted version of the original fixed-point data sample 150.

Other versions of the fixed-point to floating-point translator 110 may also be employed in system 100. For example, instead of the multiplier 240, a shifter may be utilized which takes the exponent 160 as the number of places to shift the decimal point in the fixed-point data sample 150 to the left to normalize that value.

The particular fixed-point to floating-point translator 110 described above assumes that the fixed-point data sample 150 will always be greater than or equal to one. Such an assumption is valid in various applications that may employ embodiments of the current invention. However, if such an assumption cannot be made, other embodiments may be employed to accommodate those situations. For example, the translator 110 may be configured to pre-shift small values of the fixed-point input number 150 prior to determining the MSB position 250 of the highest “one.”

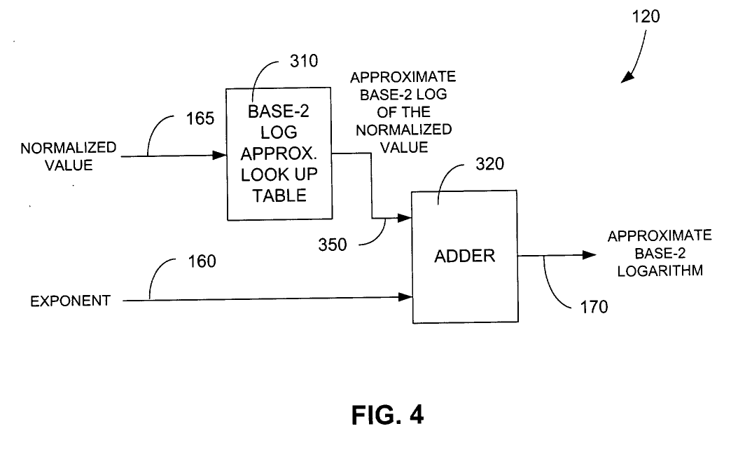

The exponent 160 and the normalized value 165, making up a floating point version of the fixed-point data sample 150 in the form ((normalized value 165)*2^{(exponent 160)}) are then taken as input by the base-2 logarithm estimator 120 to generate an approximate base-2 logarithm 170. In this specific embodiment, the base-2 logarithm estimator 120, as shown in FIG. 4, employs the mathematical principle that the logarithm of two numbers multiplied together equals the sum of their separate logarithms. Specifically, with respect to this particular situation:

$${log}_{2} ( ( normalized value 165 ) * {2}^{( exponent 160 )} ) = \\ ( {log}_{2} ( normalized value 165 ) ) + ( {log}_{2} ( {2}^{( exponent 160 )} ) ) = \\ ( {log}_{2} ( normalized value 165 ) ) + ( exponent 160 )$$

In FIG. 4, an approximate base-2 logarithm 350 of the normalized value 165 is generated by way of a base-2 logarithm approximation lookup table 310. For each possible normalized value 165, a corresponding approximate base-2 logarithm 350 is produced. The number of entries required in the base-2 logarithm approximation lookup table 310 depend on the number of bits in the normalized value 165 that are thought to be significant for the purpose of estimating the bin number. This, in turn, depends on the number and spacing of the bins of the histogram being computed. For example, for the histogram of FIG. 1, a base-2 logarithm approximation lookup table 310 having 128 entries, with each entry containing a fixed-point number of seven bits, was found to be adequate. In that embodiment, the seven bits used to index the lookup table 310 are the seven most significant fractional bits of the normalized value 165. In normalized binary values, the first bit to the left of the decimal point is always the leftmost “one” bit, and so may be assumed to have that value. For example, if the normalized value 165 has a value of 1.0111010, the value “0111010” is used to index the base-2 logarithm approximation lookup table 310, with the approximate base-2 logarithm 350 indexed by that value being the base-2 logarithm of 1.0111010.

Additionally, according to this embodiment, the approximate base-2 logarithm 350 for the normalized value 350 stored at that location in the base-2 logarithm approximation lookup table 310 contains the mean of the logarithms for 1.0111010 and 1.0111011 with 7-bit precision. In some embodiments, the mean values stored in this lookup table 310 may be truncated. However, rounding the values is believed to result in a more accurate approximation. This approximation should be accurate to within half of one bin's width from the actual bin in which the fixed-point data sample resides for the actual bin number to result from system 100.

Referring again to FIG. 4, the value of the approximate base-2 logarithm 350 of the normalized value 350 is then added directly to the exponent 160 by way of an adder 320, thereby producing the approximate base-2 logarithm 170 of the data sample 150, 151. The adder 320 may be a simple unit capable of adding an integer value, such as the exponent 160, to a fixed-point number containing a fraction, or a more fully functional arithmetic unit.

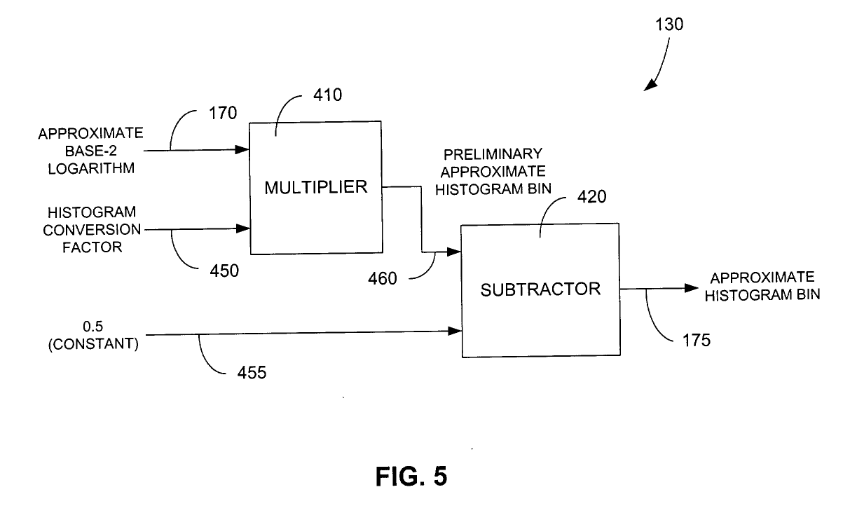

The approximate base-2 logarithm 170 from the estimator 120 is then taken as input by the approximate histogram bin calculator 130 to generate an approximate histogram bin number 175, as displayed in FIG. 5. The approximate base-2 logarithm 170 is first multiplied by a histogram conversion factor 450 to yield a preliminary approximate histogram bin number 460. The value of the conversion factor 450 is a constant whose value depends upon the characteristics of the histogram being computed. For the histogram of FIG. 1, for example, which uses 0.1 dB increments relating to base-10 logarithms, the conversion from a base-2 logarithm is accomplished as follows, employing the mathematical identity that logy (X)=(log_{Z}(X))/(log_{Z}(Y)):

b≈100(log₁₀P)=100((log₂P)/(log₂(10)))=(100/(log₂(10))) (log₂P)

Therefore, the conversion factor 450 in this particular case is (100/(log₂(10))).

Referring again to FIG. 5, a constant value 455 of 0.5 is subtracted from the preliminary approximate histogram bin number 460 to yield the approximate histogram bin number 175 by way of a subtractor 420. The preliminary approximate histogram bin number 460 is reduced by 0.5 before being truncated so that the number of possible bins into which the data sample 150, 151 may be placed is reduced to two. Without this correction, any of three possible bin numbers may indicate the correct bin, due to a maximum possible error of plus or minus one-half of a bin number due to the approximation of the base-2 logarithm accomplished in the base-2 logarithm estimator 120. For example, assume the approximate base-2 logarithm 170 represents a value centered within bin b₁. With a possible error of +/−0.5 in either direction, any of bins b, −1₁−1, b₁, or b₁+1 could be the correct bin number. Subtracting 0.5 from b₁ shifts the error to +0/−1, the range of which lies within either b₁−1 or b₁, thereby reducing the number of possibly correct bins from three to two.

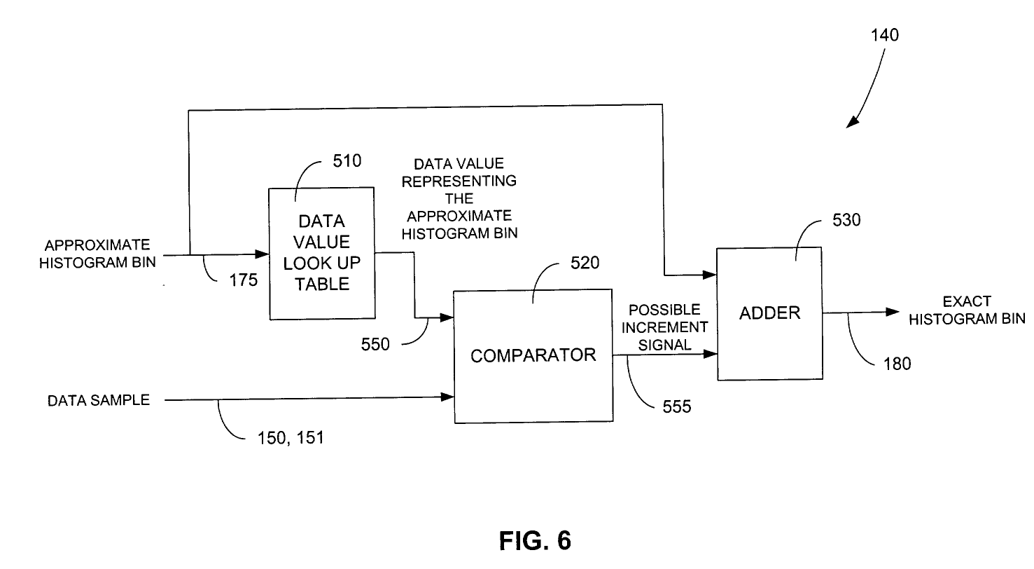

To determine which of the two possible bin numbers is correct, the histogram bin adjuster 140, from FIG. 6, utilizes the approximate bin number 175 as input to a data value lookup table 510, which holds a data value 550 representing the top boundary value for each possible bin number. The data value 550 is in fixed-point format for system 100, and in floating-point format for system 101, so that the format of the data value 550 will match that of the data sample 150, 151. A comparator 520 is then used to compare the data value 550 with the data sample 150, 151. If the data value 550 is less than the data sample 150, 151, the comparator 520 causes the approximate histogram bin number 175 to be increased by one by way of a possible increment signal 555 to an adder 530 to produce an exact histogram bin number 180. Otherwise, if the data value 550 is greater than or equal to the data sample 150, 151, the comparator 555 indicates through the possible increment signal 555 that nothing is to be added to the approximate histogram bin number 175. In other words, in that case the value of the approximate histogram bin number 175 does not have to be adjusted, and that value is already equal to the exact histogram bin number 180.

Other implementations of the histogram bin adjuster 140 may also be employed. For example, the data value 550 may represent another value with respect to each possible bin number, such as its bottom boundary value. The remainder of the histogram bin adjuster 140 would then need to be modified according to that particular change.

Assuming an implementation in digital hardware, the systems 100, 101 provides significant benefits in terms of space savings in electronic devices, such as application-specific ICs (ASICs), field-programmable gate arrays (FPGAs), and the like. This space efficiency is due primarily to the relative lack of large arithmetic units and lookup tables necessary to realize embodiments of the invention.

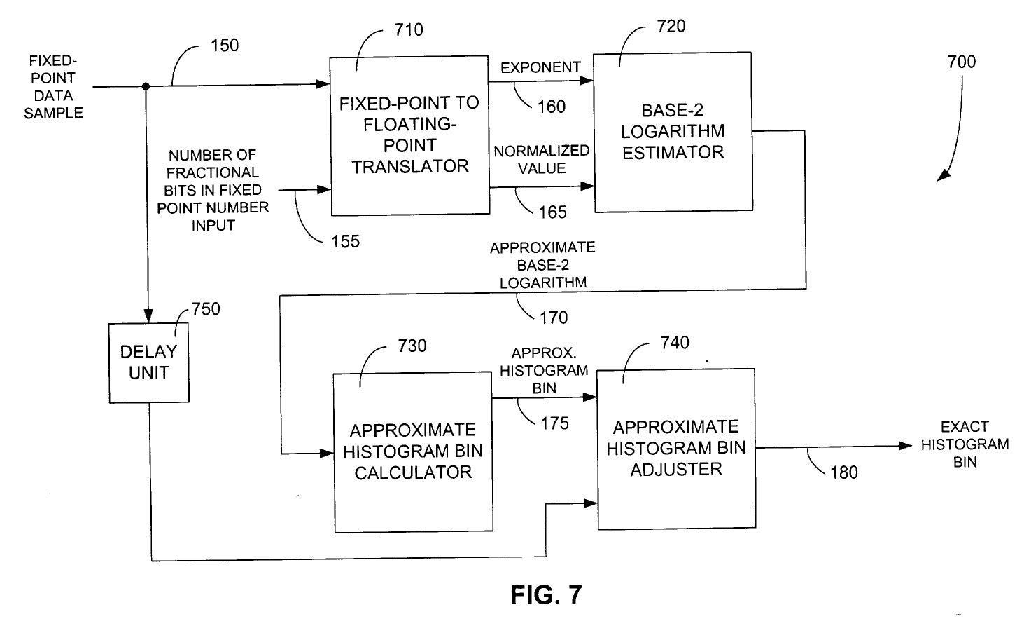

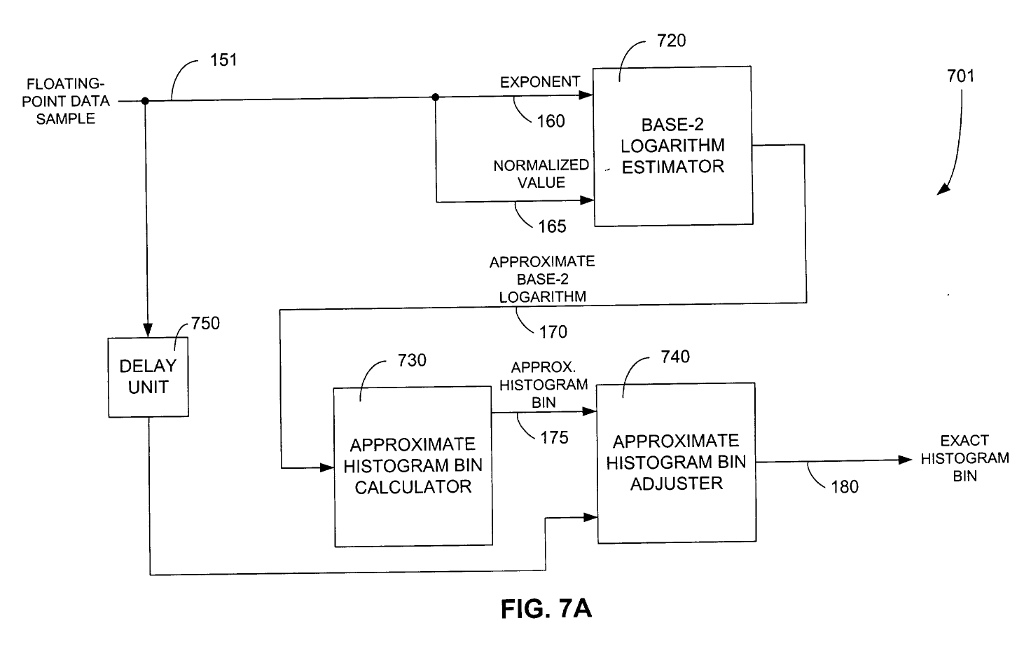

To reap the maximum speed benefits from the present invention, embodiments that implement a pipelined architecture, allowing several different consecutive data samples to be processed concurrently at various stages within the systems 100, 101, are likely to produce the highest data rates. One possible implementation of a pipelined architecture for systems 100, 101 would employ memory registers to hold the values to be processed at various points along the system components 110, 120, 130, and 140. Certain of these registers would be utilized as multi-stage delay units, such as first-in, first-out (FIFO) buffers, to hold data items while awaiting the arrival of other data items with which they are to be processed in tandem. For example, FIG. 7 and FIG. 7A show pipelined systems 700, 701 fashioned after the systems 100, 101 in FIG. 2 and FIG. 2A, respectively. The data sample 150, 151 is an input to both the translator 710 in system 700 (or the base-2 logarithm estimator 720 in system 701) and the approximate histogram bin adjuster 740. As a result, the data sample 150, 151 must be delayed in the pipelined systems 700, 701 by the finite amount of time required for generating the approximate base-2 logarithm 170 with which it is associated, as well as for generating the approximate histogram bin number 175. This delay is accomplished by way of a delay unit 750, which typically delays the arrival of the data sample 150, 151 at the approximate histogram bin adjuster 740 by a preset number of system clock cycles. Additionally, several such delay units also are likely to be implemented within pipelined components 710, 720, 730, 740 of the pipelined systems 700, 701, with the number of specific delay units and length of the delays dependent upon the actual implementation of pipelined system 700, 701 selected.

Although the pipelined systems 700, 701 could ultimately extend the time required to process any particular data sample 150, 151, the overall throughput of the pipelined systems 700, 701 is augmented over similar non-pipelined embodiments.

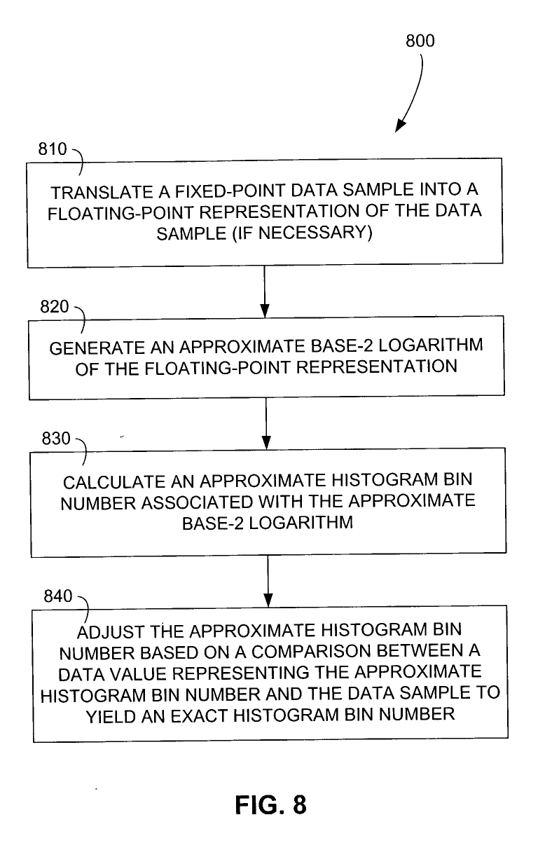

The present invention may also be embodied as a method 800 of computing a histogram with exponential spacing of bins, as shown in FIG. 8. Assuming a fixed-point data sample, that sample is first translated into a floating-point representation of the data sample (step 810). The existence of a floating-point data sample negates the need for the translating step. An approximate base-2 logarithm of the floating-point representation is then generated (step 820). An approximate bin number associated with the approximate base-2 logarithm is then calculated (step 830). The approximate bin number is then adjusted based on a comparison between a data value representing the approximate bin number and the data sample to yield an exact histogram bin number (step 840). Each one of these steps may be further composed of several substeps as described above concerning the particular system embodiments of the present invention.

From the foregoing, the embodiments of the invention discussed above have been shown to compute histograms with exponential bin spacing in a space-efficient manner, in terms of either hardware or software implementation, while generating results in real-time. Additionally, the data rate of the generated bin numbers may be increased by utilizing a pipelined architecture so that each portion of the system or method may be more efficiently utilized. Furthermore, other specific systems and methods embodying the invention are also possible. Therefore, the present invention is not to be limited to the specific forms so described and illustrated; the invention is limited only by the claims.

What is claimed is:

1. A system for computing a histogram with exponential spacing of bins, comprising:
a base-2 logarithm estimator configured to generate an approximate base-2 logarithm of a floating-point representation of a data sample;
an approximate histogram bin calculator configured to calculate an approximate histogram bin number associated with the approximate base-2 logarithm; and
a histogram bin adjuster configured to adjust the approximate histogram bin number based on a comparison between a data value representing the approximate histogram bin number and the data sample to yield an exact histogram bin number.

2. The system of claim 1, further comprising:
a translator configured to translate a fixed-point representation of the data sample into the floating-point representation.

3. The system of claim 2, wherein the translator comprises:
a priority encoder configured to indicate the location of the most significant “one” bit in the fixed-point representation;
a subtractor configured to subtract the number of fractional bits represented in the fixed-point representation from the location of the most significant “one” bit in the fixed-point representation to yield an exponent of the floating-point representation;
a multiplier lookup table configured to produce a multiplier value related to the exponent; and
a multiplier configured to multiply the fixed-point representation by the multiplier value to generate a normalized value of the floating-point representation.

4. The system of claim 2, wherein the translator comprises:
a priority encoder configured to indicate the location of the most significant “one” bit in the fixed-point representation;
a subtractor configured to subtract the number of fractional bits represented in the fixed-point representation from the location of the most significant “one” bit in the fixed-point representation to yield an exponent of the floating-point representation; and
a shifter configured to shift the fixed-point representation by the value of the exponent to generate a normalized value of the floating-point representation.

5. The system of claim 1, wherein the base-2 logarithm estimator comprises:
a base-2 logarithm approximation lookup table configured to produce an approximate base-2 logarithm of the normalized value; and
an adder configured to add the approximate base-2 logarithm of the normalized value to the exponent to yield the approximate base-2 logarithm of the floating-point representation.

6. The system of claim 5, wherein the approximate base-2 logarithm of the normalized value produced by the base-2 logarithm approximation lookup table is rounded.

7. The system of claim 5, wherein the approximate base-2 logarithm of the normalized value produced by the base-2 logarithm approximation lookup table is truncated.

8. The system of claim 1, wherein the approximate histogram bin calculator comprises:
a multiplier configured to multiply the approximate base-2 logarithm of the floating-point representation by a histogram conversion factor to yield a preliminary approximate histogram bin number; and
a subtractor configured to subtract one-half from the preliminary approximate histogram bin number to produce the approximate histogram bin number.

9. The system of claim 1, wherein the histogram bin number adjuster comprises:
a data-value lookup table configured to produce the data value representing the approximate histogram bin number, the data value essentially being equivalent to the top boundary value of the bin associated with the approximate histogram bin number;
a comparator configured to compare the data sample with the data value representing the approximate histogram bin number; and
an adder configured to increment the approximate histogram bin number if the data sample is greater than the data value representing the approximate histogram bin number.

10. The system of claim 1, wherein the system is implemented in a pipelined fashion.

11. The system of claim 1, wherein the system is implemented in digital hardware.

12. The system of claim 1, wherein the system is implemented in software.

13. An electronic test instrument configured to incorporate the system of claim 1.

14. A system for computing a histogram with exponential spacing of bins, comprising:
means for generating an approximate base-2 logarithm of a floating-point representation of a data sample;
means for calculating an approximate histogram bin number associated with the approximate base-2 logarithm; and
means for adjusting the approximate histogram bin number based on a comparison between a data value representing the approximate histogram bin number and the data sample to yield an exact histogram bin number.

15. The system of claim 14, further comprising:
means for translating a fixed-point representation of the data sample into the floating-point representation.

16. A method of computing a histogram with exponential spacing of bins, comprising:
generating an approximate base-2 logarithm of a floating-point representation of a data sample;
calculating an approximate histogram bin number associated with the approximate base-2 logarithm; and
adjusting the approximate histogram bin number based on a comparison between a data value representing the approximate histogram bin number and the data sample to yield an exact histogram bin number.

17. The method of claim 16, further comprising:
translating a fixed-point representation of the data sample into the floating-point representation.

18. The method of claim 17, wherein the translating step comprises:
determining the location of the most significant “one” bit in the fixed-point representation;
subtracting the number of fractional bits represented in the fixed-point representation from the location of the most significant “one” bit in the fixed-point representation to yield an exponent of the floating-point representation; and
multiplying the fixed-point representation by a multiplier value related to the exponent to generate a normalized value of the floating-point representation.

19. The method of claim 17, wherein the translating step comprises:
determining the location of the most significant “one” bit in the fixed-point representation;
subtracting the number of fractional bits represented in the fixed-point representation from the location of the most significant “one” bit in the fixed-point representation to yield an exponent of the floating-point representation; and
shifting the fixed-point representation by the value of the exponent to generate a normalized value of the floating-point representation.

20. The method of claim 16, wherein the generating step comprises:
producing an approximate base-2 logarithm of the normalized value; and
adding the approximate base-2 logarithm of the normalized value to the exponent to yield the approximate base-2 logarithm of the floating-point representation.

21. The method of claim 20, wherein the approximate base-2 logarithm of the normalized value is rounded.

22. The method of claim 20, wherein the approximate base-2 logarithm of the normalized value is truncated.

23. The method of claim 16, wherein the calculating step comprises:
multiplying the approximate base-2 logarithm of the floating-point representation by a histogram conversion factor to yield a preliminary approximate histogram bin number; and
subtracting one-half from the preliminary approximate histogram bin number to produce the approximate histogram bin number.

24. The method of claim 16, wherein the adjusting step comprises:
producing the data value representing the approximate histogram bin number, the data value essentially being equivalent to the top boundary value of the bin associated with the approximate histogram bin number;
comparing the data sample with the data value representing the approximate histogram bin number; and
incrementing the approximate histogram bin number if the data sample is greater than the data value representing the approximate histogram bin number.

25. The method of claim 16, wherein the method is implemented in a pipelined fashion.

26. An electronic test instrument configured to incorporate the method of claim 16.
